(19) United States
(12) Patent Application Publication
(10) Pub. No.: US 2014/0299676 A1
(43) Pub. Date: Oct. 9, 2014

(54) DUAL SOLENOID DUAL ANGLE ENTRY MULTI-PHYSICS FUEL ATOMIZER

(71) Applicant: ENGINETICS, LLC, Miami Beach, FL (US)

(72) Inventors: Roderick James Harris, Northville, MI (US); Joseph Lull, South Haven, MI (US)

(73) Assignee: Enginetics, LLC, Miami Beach, FL (US)

(21) Appl. No.: 13/857,292

(22) Filed: Apr. 5, 2013

(51) Int. Cl. F02M 61/18; F02M 61/16

(52) U.S. Cl. CPC F02M 61/182; F02M 61/168
USPC 239/408; 29/888.01

(57) ABSTRACT

A metering system includes a housing, a gas metering member, and a fuel metering member. The housing includes a first cavity arranged at a first non-parallel angle relative to a longitudinal axis of the housing, and a second cavity arranged at a second non-parallel angle relative to the longitudinal axis. The gas metering member is positioned in the first cavity and configured to control flow of gas to the fuel atomizer. The fuel metering member is positioned in the second cavity and configured to control flow of fuel to the fuel atomizer.

### TECHNICAL FIELD

The present disclosure is directed to fuel systems, and more particularly directed to packaging of dual fluids fuel delivery systems and related methods.

### BACKGROUND

Many types of devices have been developed over the years for the purpose of converting liquids into aerosols or fine droplets readily converted into a gas-phase. Many such devices have been developed, for example, to prepare fuel for use in internal combustion engines. To optimize fuel oxidation within an engine's combustion chamber, the fuel must be vaporized, homogenized with air, and in a chemically-stoichiometric gas-phase mixture. Ideal fuel atomization and vaporization enables more complete combustion and consequently lowers engine out pollution.

More specifically, relative to internal combustion engines, stoichiometry is a condition where the amount of oxygen required to completely burn a given amount of fuel is supplied in a homogeneous mixture resulting in optimally correct combustion with no residues remaining from incomplete or inefficient oxidation. Ideally, the fuel should be completely vaporized, intermixed with air, and homogenized prior to ignition for proper oxidation. Non-vaporized fuel droplets do not ignite or combust completely in conventional internal and external combustion engines, which degrades fuel efficiency and increases engine out pollution.

Attempts to reduce or control emission byproducts by adjusting temperature and pressure typically affects the NOₓ byproduct. To meet emission standards, these residues must be dealt with, typically requiring after treatment in a catalytic converter or a scrubber. Such treatment of these residues results in additional fuel costs to operate the catalytic converter or scrubber and may require additional component costs as well as packaging and mass implications. Accordingly, any reduction in engine out residuals resulting from incomplete combustion would be economically and environmentally beneficial.

An engine running a closed loop in which λ=1 (e.g., when λ equals the ratio of air/fuel ratio (AFR) divided by the stoichiometric air/fuel ratio (AFR_{stoich}) is targeted will typically be operating at or near stoichiometery. If the fuel is not completely vaporized, the engine management system (EMS) will add extra fuel to ensure that stoichiometery is reached as the oxygen sensor is monitoring excess oxygen in the exhaust. A reduction in efficiency caused by fuel not being completely vaporized results from extra fuel being added to ensure stoichiometery is achieved. Fuel energy is wasted and unnecessary pollution is created when the fuel is not completely vaporized. Thus, by further breaking down and more completely vaporizing the fuel-air mixture, better fuel efficiency may be available.

Many attempts have been made to alleviate the above-described problems with respect to fuel vaporization and incomplete fuel combustion. In automobile engines, for example, inlet port or direct fuel injection has almost universally replaced carburetion for fuel delivery. Fuel injectors spray fuel directly into the inlet port or cylinder of the engine and are controlled electronically. Injectors facilitate more precise metering and control of the amount of fuel delivered to each cylinder independently relative to carburetion. This reduces or eliminates charge transport time, which facilitates optimal transient operation. Nevertheless, the fuel droplet size of a fuel injector spray is not optimal and there is little time for the fuel to mix with air prior to ignition.

Furthermore, packaging constraints in modern engines require tight integration of subassembly components to meet the demands associated with limited space available along an exterior of the engine block. Challenges exist in providing fuel and gas control to create desired fuel injector spray while addressing other concerns such as space limitations.

### SUMMARY

The principles described herein may address some of the above-described deficiencies and others. Specifically, some of the principles described herein relate to liquid processor apparatuses and methods.

One aspect provides a metering system for a fuel atomizer. The metering system includes a housing, a gas metering member, and a fuel metering member. The housing includes a first cavity arranged at a first non-parallel angle relative to a longitudinal axis of the housing, and a second cavity arranged at a second non-parallel angle relative to the longitudinal axis. The gas metering member is positioned in the first cavity and configured to control flow of gas to the fuel atomizer. The fuel metering member is positioned in the second cavity and configured to control flow of fuel to the fuel atomizer.

The first and second non-parallel angles may be the same. At least a portion of the first cavity may be positioned proximal of the second cavity. A distal end of the second cavity may intersect the longitudinal axis of the housing. The first and second non-parallel angles may be in the range of about 5° to about 35° relative to the longitudinal axis. The housing may further include a circumferential channel arranged in flow communication with the first cavity and the fuel atomizer. The housing may include a plurality of gas channels extending from the fuel atomizer to the circumferential channel to provide flow communication therebetween. The plurality of gas channels may be arranged at a non-parallel angle relative to the longitudinal axis. The gas may include air and the fuel metering member may comprise a fuel injector.

Another aspect of the present disclosure relates to a method of assembling a fuel atomizer. The method includes providing a housing, a gas metering member, a fuel metering member, and a fuel atomizer portion. The housing includes first and second cavities each positioned at an angle relative to a longitudinal axis of the housing, a gas flow path extending from the first cavity to the fuel atomizer portion, and a fuel path extending from the second cavity to the fuel atomizer portion. The method further includes inserting the gas metering member into the first cavity, the gas metering member providing flow control of gas to the fuel atomizer portion, and inserting the fuel metering member into the second cavity, the fuel metering member providing flow control of fuel to the fuel atomizer portion.

At least a portion of the first cavity may be spaced proximal of the second cavity. The first and second cavities may be arranged parallel to each other. The gas metering member may extend further proximally from the housing than the fuel metering member when the fuel atomizer is assembled.

A further aspect of the present disclosure relates to a pre-combustion fuel preparation device, which includes a housing, a mixing chamber, a gas metering member, and a fuel metering member. The housing includes first and second cavities each being arranged at an angle relative to a longitudinal axis of the housing. The gas metering member is positioned in the first cavity and operable to deliver gas to the mixing chamber. The fuel metering member is positioned in the second cavity and operable to deliver fuel to the mixing chamber to mix with the gas.

The mixing chamber may be configured to atomize the fuel. The first and second cavities may be arranged parallel to each other. The housing may further include a circumferential channel positioned distal of and in flow communication with a distal end of the first cavity. The housing may further include a plurality of inlet channels extending from the circumferential channel to the mixing chamber. A distal end of the second cavity may open directly into the mixing chamber. The first and second cavities may be arranged in a common plane.

### BRIEF DESCRIPTION OF THE DRAWINGS

The accompanying drawings illustrate certain embodiments discussed below and are a part of the specification.

FIG. 1 is a perspective view of an example fuel delivery device in accordance with the present disclosure.

FIG. 2 is an exploded perspective view of the fuel delivery device of FIG. 1.

FIG. 3 is a cross-sectional view of the fuel delivery device of FIG. 1.

FIG. 4 is an exploded view of the fuel delivery device shown in FIG. 3.

FIGS. 5-8 show example operational steps for using the fuel delivery device of FIG. 3.

FIG. 9 shows the fuel delivery device of FIG. 3 connected to a rail, which delivers a supply of air and fuel to the fuel delivery device.

Throughout the drawings, identical reference characters and descriptions indicate similar, but not necessarily identical elements.

### DETAILED DESCRIPTION

Illustrative embodiments and aspects are described below. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present disclosure is directed to dual fluids fuel delivery systems and related methods of fuel delivery and packaging of a dual fluids delivery device. One of the two fluids comprises a gas such as air or an oxidant. Throughout the present disclosure, the terms oxidizer, oxidant and air may be used in place of the term gas, since the gas does not necessarily have the properties of an oxidant. The other fluid comprises fuel in the form of, for example, liquid fuel. The other fluid may generally be referred to as a liquid, which may or may not include a fuel. Internal of the fuel delivery system, the gas physically interacts with the fuel to provide initial breakup of the fuel and to drive the fuel through exit holes to form a spray plume. The spray plume is delivered to a combustion chamber of an engine.

The fuel delivery system provides metering of two separate fluids. Metering of two fluids as unique and independent events may provide additional flexibility and control for the fuel delivery system, and may provide improved overall performance.

Packaging constraints in modern engines require tight integration of subassembly components. The dual metering elements of the fuel delivery system disclosed herein may be arranged such that minimum space is consumed while maintaining viability and functional robustness. One way to address the minimum space requirement is to utilize a pair of metering devices oriented on a single body or housing of the fuel delivery system. In one example, the housing of the fuel delivery device may be used as an integral part of the metering element componentry.

In one example, a single housing of the fuel delivery system includes first and second ports configured to receive separate first and second metering members. The first (e.g., gas) metering member and associated seat in the housing may be arranged at an angle relative to a longitudinal axis of the housing. An outlet opening of the gas metering member may intersect with an annular gas cavity within the housing. The housing may include a plurality of inlet channels that provide flow communication between the annular gas cavity and a mixing (e.g., atomizer) chamber.

The fuel metering member and associated seat in the housing may also be arranged at an angle relative to the longitudinal axis of the housing. Typically, a distal end of the fuel metering member, or at least a fuel outlet of the fuel metering member, is aligned coaxially with the longitudinal axis. The fuel metering member delivers a volume of fuel centrally along the longitudinal axis into the mixing chamber.

The angle at which the gas metering member and fuel metering member are oriented relative to the longitudinal axis is typically in the range of about 5° to about 35°. Typically, the angle for each of the gas metering member and fuel metering member is the same such that the metering members are arranged in parallel to each other. The angles selected for the gas metering member and fuel metering member are selected to limit the distance that either one of the metering members extends outside of a maximum outer profile of the housing when viewed along the longitudinal axis. Minimizing a maximum outer profile of the fuel delivery device generally may provide advantages related to reduced space requirements on the engine.

In operation, gas is injected into the annular cavity of the housing the gas metering member. The gas flows through the inlet channels into the mixing chamber. The inlet channels distribute and direct the charge of gas substantially equally into the mixing chamber where the gas reacts with a volume of fuel delivered by the fuel metering member into the mixing chamber. The mixing chamber and other features of the fuel delivery device arranged downstream of the mixing chamber provide breakdown of the fuel into smaller droplet sizes or clusters of droplets. Details concerning example features for use with the fuel delivery systems described herein are disclosed in U.S. Patent Publication No. 2011/0284652, which is incorporated herein in its entirety by this reference.

The gas and fuel metering members may be oriented along a common centerline. This common centerline may extend between multiple fuel delivery devices mounted to a single engine. A single combined air/fuel rail, manifold or connector may be placed over the inlets to the gas and fuel metering members. In general, the air/fuel rail may be used to secure the one or more fuel delivery systems into an inlet manifold or cylinder head of an engine.

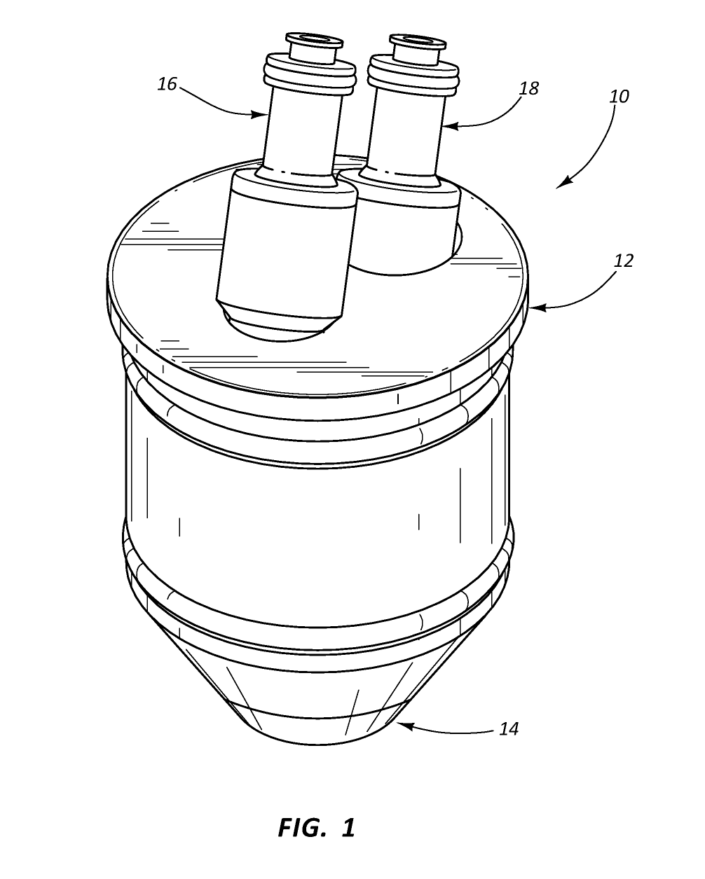

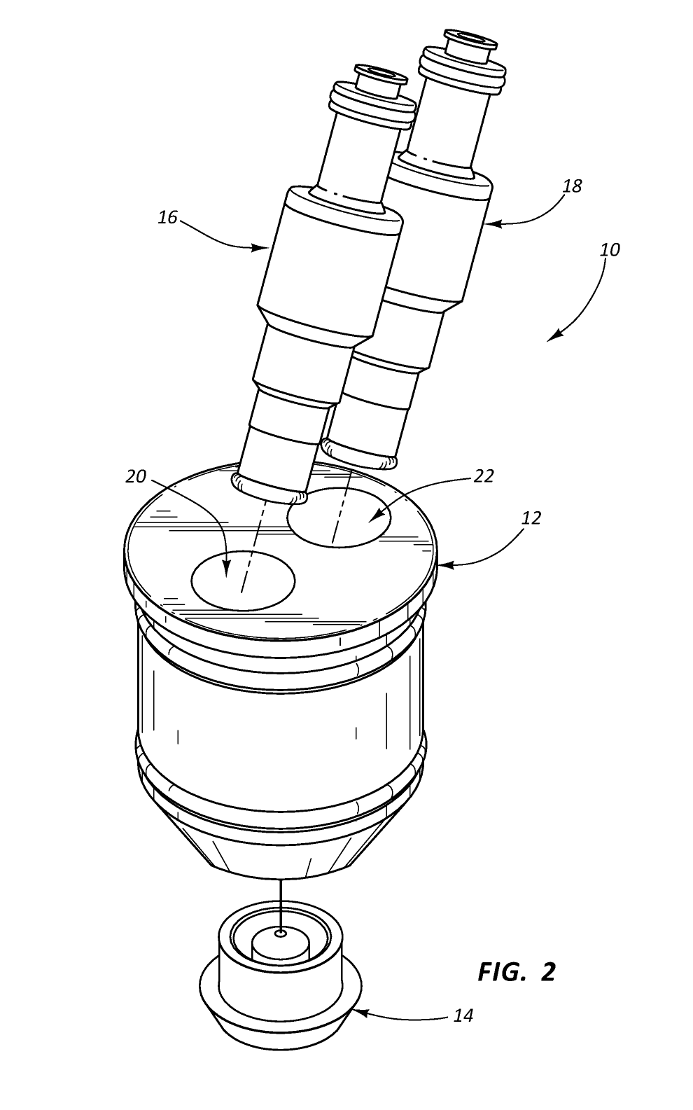

Referring to FIGS. 1 and 2, an example fuel delivery device 10 is shown including a housing 12, an atomizer portion 14 (also referred to as a nozzle 14), an gas metering device 16, a fuel metering device 18, and first and second o-rings 17, 19. The housing 12 includes first and second cavities 20, 22, which receive the gas and fuel metering devices 16, 18, respectively. The atomizer portion 14 is positioned at an opposite end of housing 12 from openings into the first and second cavities 20, 22. The atomizer portion 14 may include a plurality of features configured to help break down the size of the fuel to have a smaller Sauder mean diameter (SMD) for each fuel droplet or cluster of fuel droplets.

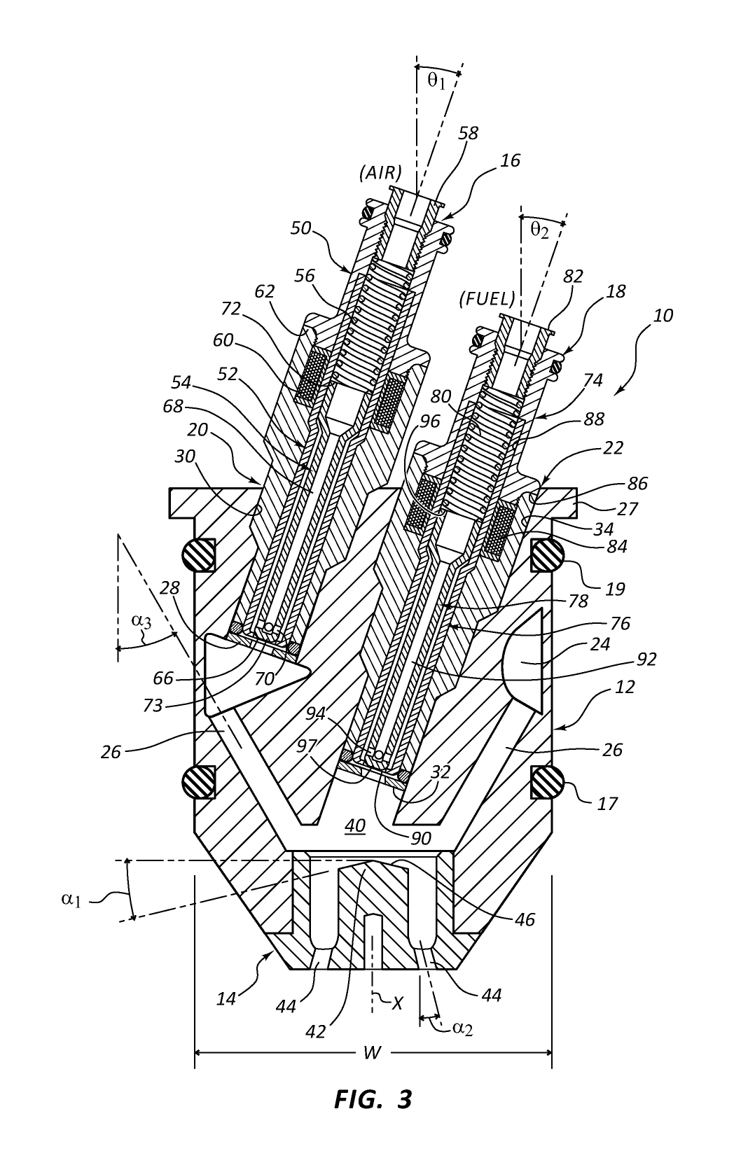

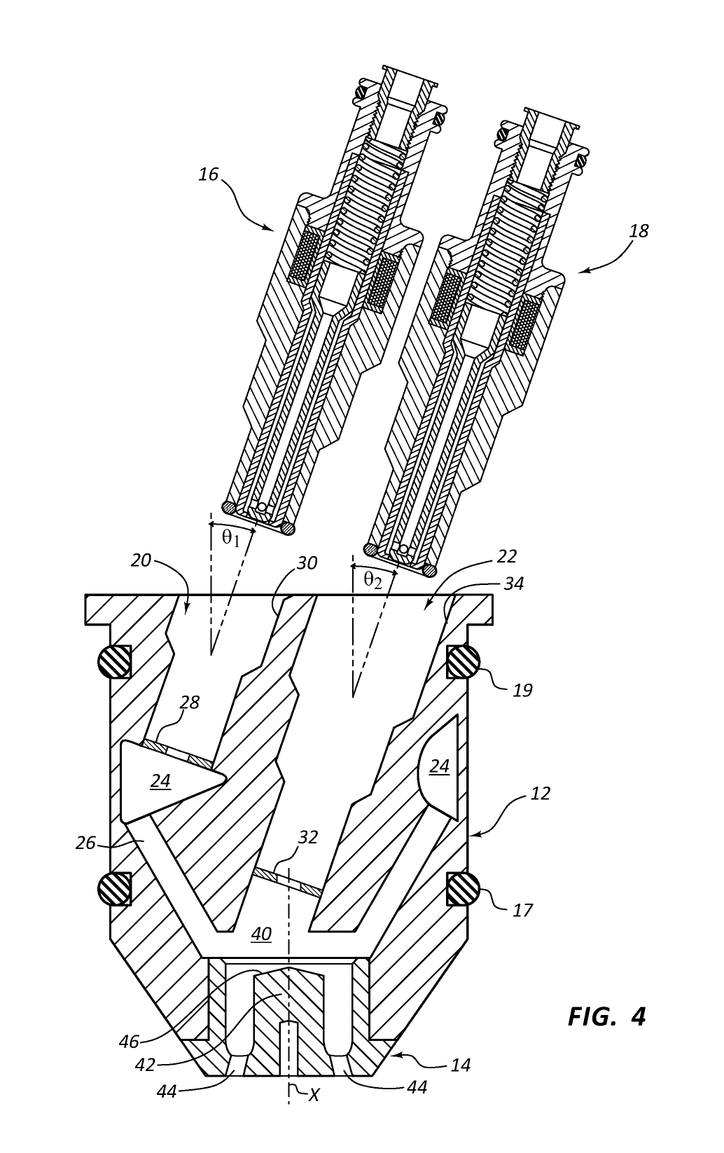

FIGS. 3 and 4 show cross-sectional views of the fuel delivery device of FIG. 1. The housing 12 is shown including an annular cavity 24 for the gas, and a plurality of inlet channels 26, which extend from the annular cavity 24 to the atomizer portion 14. The first cavity 20 of housing 12 includes distal and proximal ends 28, 30. The first cavity 20 is arranged at an angle θ₁ relative to a central axis X. The distal end 28 of first cavity 20 intersects with the annular cavity 24. A volume of gas delivered via the gas metering device 16 fills the annular cavity 24 and flows through the inlet channels 26 to the atomizer portion 14.

The second cavity 22 of the housing 12 includes distal and proximal ends 32, 34 and is arranged at an angle θ₂ relative to the central axis X. The distal end 32 is typically aligned with and intersects the central axis X. The distal end 32 may be arranged distally beyond the distal end 28 of the first cavity 20. The fuel metering device 18 may eject a volume of fluid along the central axis X into the mixing chamber of the atomizer portion 14.

The housing 12 has a maximum width W₁ as shown in FIG. 3. The width W₁ defines a maximum profile or space consumed on the exterior of the engine to which the fuel delivery device 10 is mounted. The housing 12 may include a flange 27, which may provide a position stop when inserting the fuel delivery device 10 into a cavity along the exterior of the engine. In at least some examples, the maximum width W₁ includes the width of the flange 27. A width W₂ of the entire fuel delivery device 10 may be greater than or equal to the width W₁ of the housing 12.

The atomizer portion 14 of fuel delivery device 10 includes a mixing chamber 40, a pedestal 42, and a plurality of outlet openings 44. The mixing chamber 40 is positioned between outlets of the inlet channels 26 and a contact surface 46 of the pedestal 42. The mixing chamber 40 is also positioned between the outlet of second cavity 22 and the contact surface 46 of pedestal 42. The mixing chamber 40 may also extend around and along a length of the pedestal 42.

The contact surface 46 of the pedestal 42 may be arranged at an angle α₁ relative to a plane arranged perpendicular to the central axis X. A plurality of outlet openings 44 may be arranged at an angle α₂ relative to the central axis X. The angle α₁ is typically in the range of about 5° to about 30°, and more specifically may be in the range of about 15° to about 20°. The angle α₂ is typically in the range of about 0° to about 45°, and more specifically may be in the range of about 15° to about 30°.

The inlet channels 26 of the housing 12 may be arranged at an angle α₃ relative to the central axis X. The angled arrangement of the inlet channels 26 may provide a swirl effect within the mixing chamber 40. In some arrangements, air flow through the inlet channels 26 into the mixing chamber 40 may create a plurality of vortices or a vortex flow within the mixing chamber 40. The vortex flow may provide increased efficiency in breaking up the fuel into smaller droplet sizes and may assist in improved cleanout of the atomizer portion 14 at the end of each fuel delivery cycle.

Fuel delivered from the fuel metering device 18 into the atomizer portion 14 may first contact the contact surface 46. Contacting the fuel against contact surface 46 may create initial break up of the fuel droplets. Some of the fuel may deflect off of contact surface 46 and be caught up in the gas flow. Some of the fuel may collect on the contact surface 46 and create a thin film of fuel. The thin film of fluid may flow along the contact surface 46 and be sheered off at an edge of the contact surface 46 as the flow of gas from the inlet channels 26 drives the fuel toward the outlet openings 44.

The mixture of fuel and gas within the mixing chamber 40 moves through the outlet openings 44. The reduced size of the outlet openings 44 compared to the volume of space within the mixing chamber 40 may accelerate the air/fuel mixture. In at least some cases, the air/fuel mixture accelerates to at least sonic speed. The fuel/air mixture exiting the outlet openings 44 may form a spray plume. The fuel droplets further break down into smaller sizes through evaporation into a gaseous state due to the pressure differential between the mixing chamber 40 and the area outside of the fuel delivery device 10. The spray plume may then be delivered to a combustion chamber for combustion.

The gas metering device 16 may include a base 50, a pintle housing 52, an air pintle 54, a spring 56, a plug 58 and a solenoid 60. The base 50 may include a flange 62 and a seat 64. The pintle housing 52 may be positioned in contact with the seat 64. The pintle housing 52 may include an outlet opening 66.

The air pintle 54 may include a central channel 68 and a plurality of lateral openings 70. A proximal end 72 of air pintle 54 may contact the spring 56. A distal end 73 of the air pintle 54 may contact the pintle housing 52 adjacent to the outlet opening 66 to control flow through the outlet opening 66. The spring 56 may be captured between the proximal end 72 of the air pintle 54 and the plug 58.

The solenoid 60 may operate to move the air pintle 54 axially relative to the pintle housing 52. The solenoid 60 may be operated by charging the solenoid 60, which moves the air pintle 54 proximally against biasing forces of spring 56. Moving the air pintle 54 proximally moves the distal end 73 away from the outlet opening 66 of the pintle housing 52, thereby providing a flow path through the central channel 68, lateral opening 70 and outlet opening 66. Deactivating the solenoid 60 (e.g., removing a charge applied to solenoid 60) allows the biasing forces of spring 56 to move the air pintle 54 distally to contact the distal end 73 against the pintle housing 52 to close the outlet opening 66.

The fuel metering device 18 may include the same or similar construction as the gas metering device 16. In one example, the fuel metering device 18 includes a base 74, a pintle housing 76, a fuel pintle 78, a spring 80, a plug 82 and a solenoid 84. The base 74 may include a flange 86 and a seat 88. The pintle housing 76 may include an outlet opening 90. The fuel pintle 78 may include a central channel 92, a plurality of lateral openings 94, a proximal end 96, and a distal end 97. Operating the solenoid 84 may move the fuel pintle 78 proximally to remove the distal end 97 from contacting the pintle housing 76, thereby providing a flow path through the central channel 92, lateral openings 94 and outlet opening 90. Deactivating the solenoid 84 (e.g., removing a charge applied thereto) allows the biasing force of spring 80 to force the fuel pintle 78 distally to contact the distal end 97 against the pintle housing 76 to close the outlet opening 90.

The angles θ₁, θ₂ of the first and second cavities 20, 22 of housing 12 may be the same such that the gas metering device 16 and fuel metering device 18 are arranged in parallel. The angles θ₁, θ₂ are typically in the range of about 5° to about 35°, and more specifically may be in the range of about 15° to about 25°. The angled arrangement of the gas metering device 16 and fuel metering device 18 relative to the central axis X may provide positioning of the outlet opening 90 of the fuel metering device 18 along the central axis X (see FIG. 3) and the outlet openings 66 of the gas metering device 16 exposed to the annular cavity 24 while still maintaining a minimum outer profile for the fuel delivery device 10. The greater the angles θ₁, θ₂, the greater the possible spacing between the gas metering device 16 and fuel metering device 18. However, the greater the angles θ₁, θ₂, the greater the maximum outer profile of the fuel delivery device 10. The range of angles possible for the angles θ₁, θ₂ may be optimized to provide a desired spacing between the gas metering device 16 and fuel metering device 18 to meet minimum structural requirements for the housing 12, while minimizing the maximum outer profile of the fuel delivery device 10.

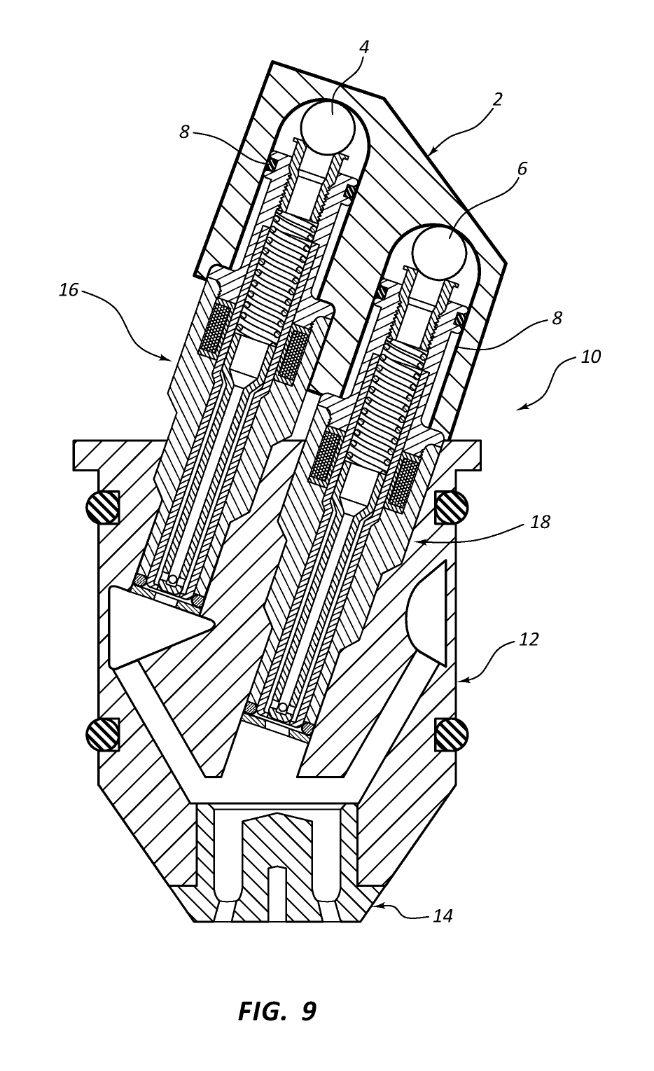

Referring now to FIG. 9, a common rail 2 having separate air and fuel channels 4, 6 may be connected to the gas and fuel metering devices 16, 18, respectively. The common rail 2 (also referred to as a manifold 2) may be connected to a plurality of fuel delivery devices 10, which are used to deliver air/fuel charges to separate combustion chambers of an engine. All of the gas metering devices 16 of the plurality of fuel delivery devices may be aligned along a common centerline or axis such that the air channel 4 may provide a flow of air to each of the gas metering devices 16. Similarly, the fuel metering devices 18 of the plurality of fuel delivery devices may be aligned along a common centerline such that the fuel channel 6 may provide a flow of fuel to each of the plurality of fuel metering devices 18.

The proximal ends of each of the gas and fuel metering devices 16, 18 of a given fuel delivery device 10 may be positioned sufficiently close to each other such that the shape and size of the rail 2 is minimized, thereby reducing space requirements for the rail 2. The gas and fuel metering devices 16, 18 may each include an o-ring 8 to provide sealed engagement between the rail 2 and the gas and fuel metering devices 16, 18.

Referring now to FIGS. 3 and 5-8, an example method of operating the fuel delivery device 10 is shown and described. The fuel delivery device 10 is initially arranged in a rest state as shown in FIG. 3. The gas and fuel metering devices 16, 18 are biased by respective springs 56, 80 into a closed position such that no gas or fuel flows into the atomizer portion 14.

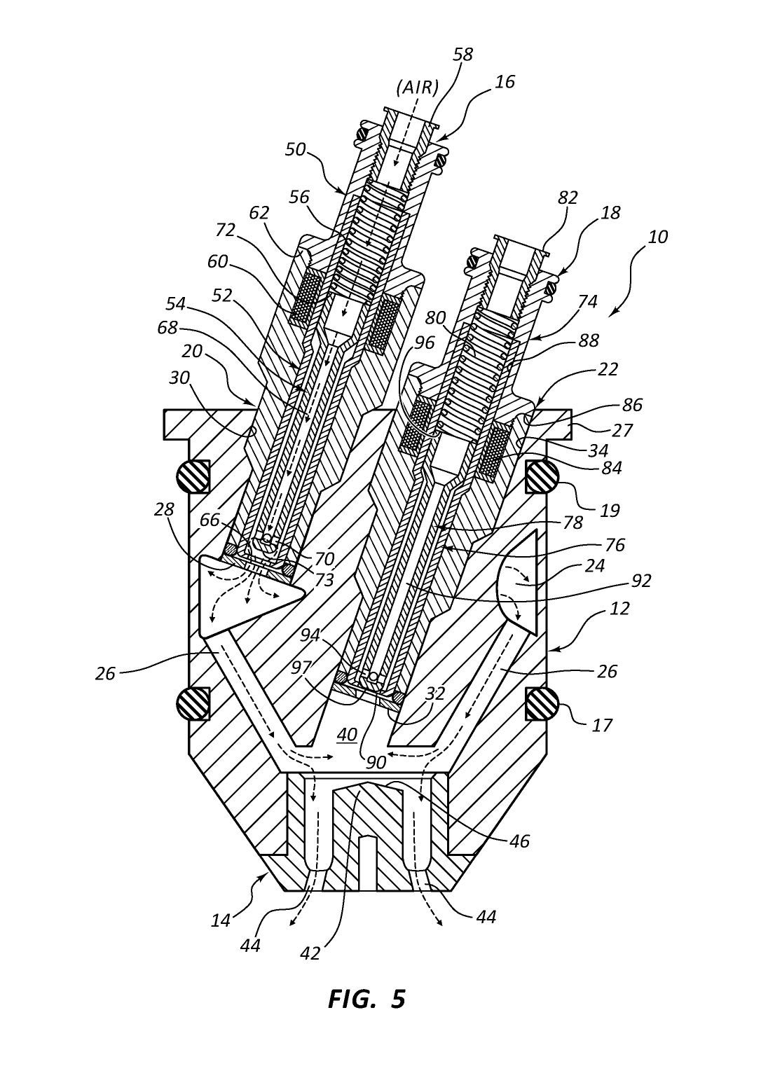

Referring to FIG. 5, a fueling sequence is initiated by actuating the gas metering device 16 to provide a flow of gas to the atomizer portion 14. The gas first fills the annular cavity 24 and then flows through the inlet channels 26 to the mixing chamber 40. The gas flows through the mixing chamber 40 and out through the outlet openings 44. As discussed above, the gas may create a vortex flow within the mixing chamber 40. The gas flow through the inlet channels 26 may be directed at least in part onto the contact surface 46 of the pedestal 42.

The gas metering device 16 is operated by actuating the solenoid 60. Actuating the solenoid 60 moves the air pintle 54 proximally against the biasing forces of spring 56 to move the distal end 73 of the air pintle 54 away from the outlet opening 66. Gas may then flow through the central channel 68, the lateral opening 70, and outlet opening 66 into the annular cavity 24.

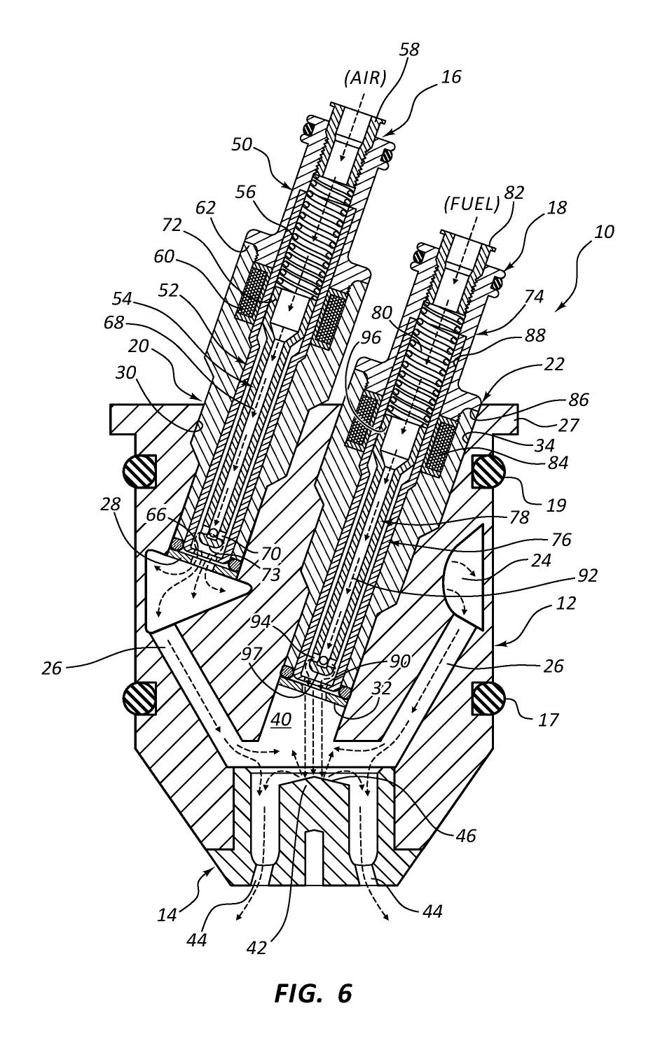

Referring to FIG. 6, the next operational step is to actuate the fuel metering device 18 to deliver a volume of fuel into the atomizer portion 14. FIG. 6 shows a flow of fuel from the fuel metering device 18 into the mixing chamber 40 and onto the contact surface 46 of the pedestal 42. The fuel mixes with the gas within the mixing chamber 40 and flows out of the outlet openings 44 to create a spray plume.

The fuel metering device 18 is operated by actuating a solenoid 84, which moves the fuel pintle 78 proximally. The distal end 97 of the fuel pintle 78 moves away from the outlet opening 90 to provide a flow path for fuel to flow through the central channel 92, the lateral openings 94, and out of the outlet opening 90 into the mixing chamber 40. As discussed above, the fuel may be delivered along the central axis X onto the pedestal 42.

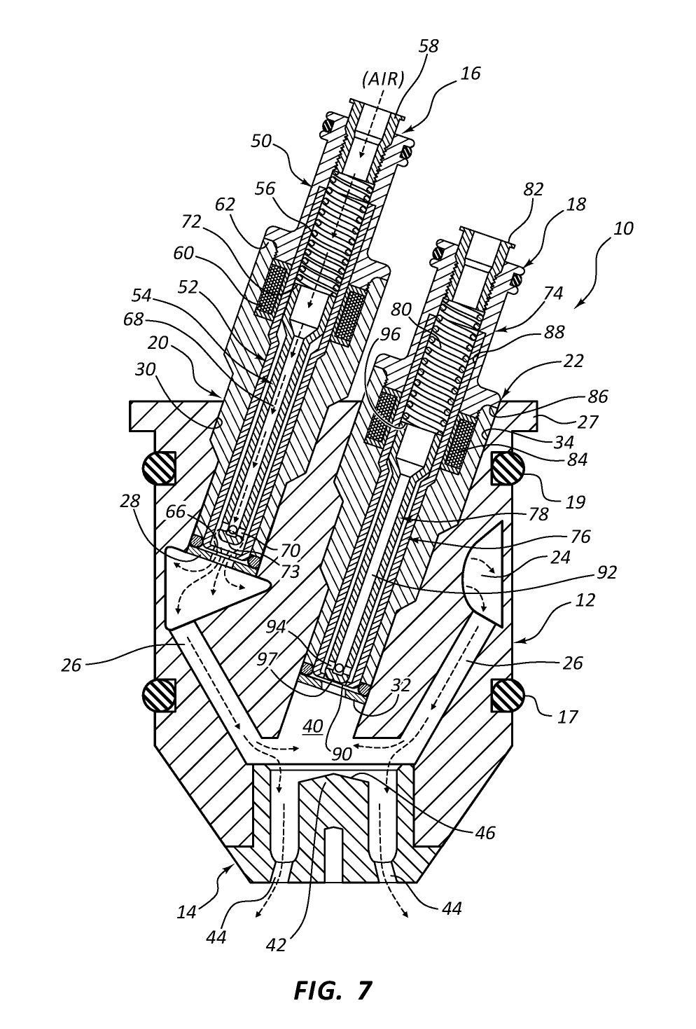

Referring now to FIG. 7, the fuel metering device 18 is operated to stop the fuel flow. The fuel metering device 18 is stopped by deactivating the solenoid 84, which causes the fuel pintle 78 to move distally by the biasing forces of spring 80 to close the outlet opening 90. Air continues to flow through the atomizer portion 14 to clear out any remaining fuel. Maintaining a flow of gas through the atomizer portion 14 after shutting off the fuel flow may be referred to as clearing out or cleaning out the atomizer portion 14.

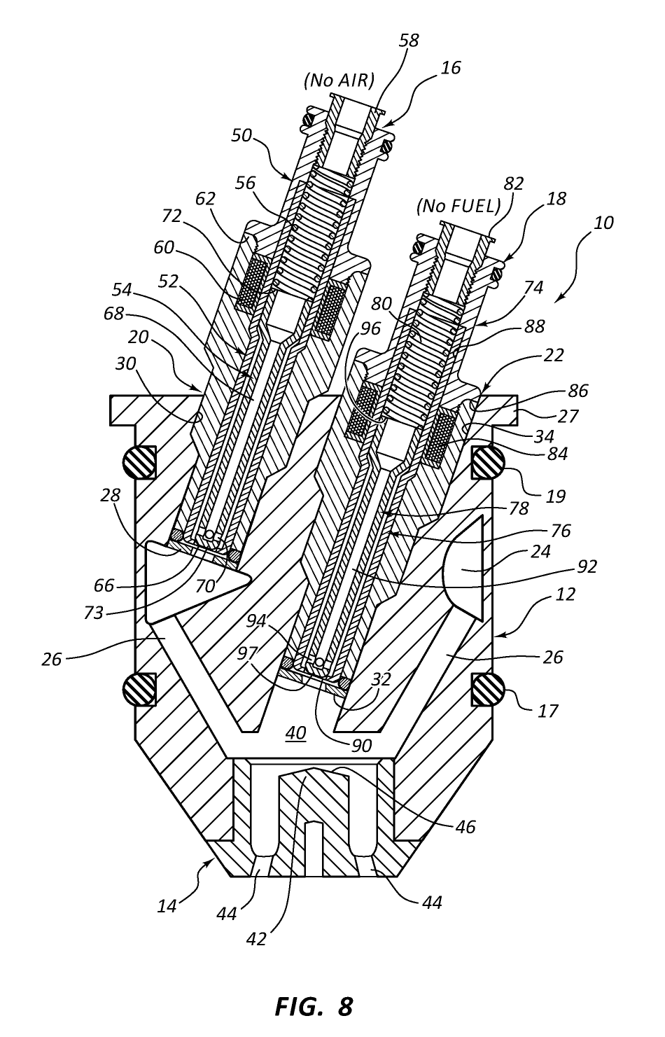

Referring to FIG. 8, the gas metering device 16 is operated to stop gas flow through the atomizer portion 14. The gas metering device 16 may be operated by deactivating the solenoid 60, which permits the air pintle 54 to move distally by the biasing force of spring 56 to close the outlet opening 66. After the gas flow is stopped, the fuel delivery device 10 is in a rest or ready state prepared for the next fuel delivery cycle.

The timing between each of the steps shown in FIGS. 3 and 5-8 may be in the range of milliseconds. The slight delays between turning on and off the gas and fuel metering devices 16, 18 may provide improved performance in the form of consistent fuel droplet size, plume shape, and down stream combustion of the fuel. In one example, a delay between opening the gas metering device 16 and opening the fuel metering device 18 may be less than about 10 milliseconds (ms), and more specifically may be in the range of about 0 ms to about 1 ms. The delay between closing the fuel metering device 18 and closing the gas metering device 16 may be less than about 10 ms, and more preferably in the range of about 0 ms to about 2 ms. The time period in which the air and fuel metering devices 16, 18 are maintained open at the same time may vary depending on a variety of parameters, including, for example, the type of fuel and/or gas being used, the type of engine, the operating condition of the engine, and the size and shape of various features of the fuel delivery device 10. In one example, the time during which both of the gas and fuel metering devices are open at the same time is less than about 20 ms, and more specifically may be in the range of about 1 ms to about 5 ms.

At least one advantage related to the systems and methods disclosed herein relates to the integration of air (gas) and fuel metering into a single housing or body. The entry (e.g., gamma) angle of the gas and fuel metering devices into the housing and the order of presentation of the fuel and gas to the atomizer portion of the device may facilitate packaging of the metering members (e.g., solenoids) such that the smallest radial protrusion beyond an outer profile of the housing by the metering members is realized.

Another possible advantage relates to gas and fuel metering element inlets for a plurality of fuel delivery devices being oriented on a common axis such that an integrated air/fuel rail with common connectors and sealing elements may be utilized, thereby providing further compact installation packaging.

The preceding description has been presented only to illustrate and describe certain aspects, embodiments, and examples of the principles claimed below. It is not intended to be exhaustive or to limit the described principles to any precise form disclosed. Many modifications and variations are possible in light of the above disclosure. Such modifications are contemplated by the inventor and within the scope of the claims. The scope of the principles described is defined by the following claims.

What is claimed is:

1. A metering system for a fuel atomizer, comprising:
a housing having a first cavity arranged at a first non-parallel angle relative to a longitudinal axis of the housing, and a second cavity arranged at a second non-parallel angle relative to the longitudinal axis;
a gas metering member positioned in the first cavity and configured to control flow of gas to the fuel atomizer;
a fuel metering member positioned in the second cavity and configured to control flow of fuel to the fuel atomizer.

2. The metering system of claim 1, wherein the first and second non-parallel angles are the same.

3. The metering system of claim 1, wherein at least a portion of the first cavity is positioned proximal of the second cavity.

4. The metering system of claim 1, wherein a distal end of the second cavity intersects the longitudinal axis of the housing.

5. The metering system of claim 1, wherein the first and second non-parallel angles are in the range of about 5° to about 35° relative to the longitudinal axis.

6. The metering system of claim 1, wherein the housing further comprises a circumferential channel arranged in flow communication with the first cavity and the fuel atomizer.

7. The metering system of claim 6, wherein the housing comprises a plurality of gas channels extending from the fuel atomizer to the circumferential channel to provide flow communication therebetween.

8. The metering system of claim 7, wherein the plurality of gas channels are arranged at a non-parallel angle relative to the longitudinal axis.

9. The metering system of claim 1, wherein the gas comprises air and the fuel metering member is a fuel injector.

10. A method of assembling a fuel atomizer, comprising:
providing a housing, a gas metering member, a fuel metering member, and a fuel atomizer portion, the housing comprising first and second cavities each positioned at an angle relative to a longitudinal axis of the housing, a gas flow path extending from the first cavity to the fuel atomizer portion, and a fuel path extending from the second cavity to the fuel atomizer portion;
inserting the gas metering member into the first cavity, the gas metering member providing flow control of gas to the fuel atomizer portion;
inserting the fuel metering member into the second cavity, the fuel metering member providing flow control of fuel to the fuel atomizer portion.

11. The method according to claim 10, wherein at least a portion of the first cavity is spaced proximal of the second cavity.

12. The method according to claim 10, wherein the first and second cavities are arranged parallel to each other.

13. The method according to claim 10, wherein the gas metering member extends further proximally from the housing than the fuel metering member.

14. A pre-combustion fuel preparation device, comprising:
a housing having first and second cavities each being arranged at an angle relative to a longitudinal axis of the housing;
a mixing chamber;
a gas metering member positioned in the first cavity and operable to deliver gas to the mixing chamber;
a fuel metering member positioned in the second cavity and operable to deliver fuel to the mixing chamber to mix with the gas.

15. The pre-combustion fuel preparation device of claim 14, wherein the mixing chamber is configured to atomize the fuel.

16. The pre-combustion fuel preparation device of claim 14, wherein the first and second cavities are arranged parallel to each other.

17. The pre-combustion fuel preparation device of claim 14, wherein the housing further comprises a circumferential channel positioned distal of and in flow communication with a distal end of the first cavity.

18. The pre-combustion fuel preparation device of claim 17, wherein the housing further comprises a plurality of inlet channels extending from the circumferential channel to the mixing chamber.

19. The pre-combustion fuel preparation device of claim 14, wherein a distal end of the second cavity opens directly into the mixing chamber.

20. The pre-combustion fuel preparation device of claim 14, wherein the first and second cavities are arranged in a common plane.
